(19) United States
(12) Patent Application Publication
(10) Pub. No.: US 2015/0350485 A1
(43) Pub. Date: Dec. 3, 2015

(54) IMAGE FORMING SYSTEM AND IMAGE FORMING METHOD

(71) Applicants: Kabushiki Kaisha Toshiba, Tokyo (JP); Toshiba Tec Kabushiki Kaisha, Tokyo (JP)

(72) Inventor: Jin Kamada, Izunokuni-shi (JP)

(73) Assignees: Kabushiki Kaisha Toshiba, Tokyo (JP); Toshiba Tec Kabushiki Kaisha, Tokyo (JP)

(21) Appl. No.: 14/291,373

(22) Filed: May 30, 2014

(51) Int. Cl. H04N 1/32; H04N 1/00; H04N 1/44

(52) U.S. Cl. CPC H04N 1/32106; H04N 1/32368; H04N 1/32037; H04N 1/4413; H04N 1/4426; H04N 1/00307; H04N 2201/0094

(57) ABSTRACT

In accordance with one embodiment, an image forming system comprises a portable terminal, a server and an image forming apparatus. The portable terminal includes a non-volatile memory and a control section. The non-volatile memory stores the personal authentication data for specifying a user. The control section sends the personal authentication data and user data to the server in a case where the remaining battery level value is less than a remaining level threshold value. The server includes a user data storage section. The user data storage section stores the personal authentication data and the user data sent from the portable terminal in an associated manner. The image forming apparatus includes a control section and a print section. The control section acquires the user data corresponding to the personal authentication data acquired from the non-volatile memory from the user data storage section. The print section prints the acquired user data.

### FIELD

Embodiments described herein relate generally to an image forming system and an image forming method.

### BACKGROUND

In recent years, with the spread of a portable terminal such as a smart phone and a tablet terminal, needs of desiring to print a document and the like created by the portable terminal are increased. However, the portable terminal is not provided with a printer for outputting the data in the portable terminal. Thus, in order to print the data in the portable terminal, it is necessary to send the data from the portable terminal to a printer through a wireless communication.

However, if the battery of the portable terminal is exhausted, the data in the portable terminal cannot be sent to the printer. Thus, there is a case where the data in the portable terminal cannot be printed.

### BRIEF DESCRIPTION OF THE DRAWINGS

FIG. 1 is a diagram illustrating an example of the constitution of an image forming system according to one embodiment;

FIG. 2 is a diagram illustrating an example of the constitution of a management apparatus 1 according to the embodiment;

FIG. 3 is a diagram illustrating an example of the constitution of a portable terminal 2 according to the embodiment;

FIG. 4 is a diagram illustrating an example of the constitution of a server 3 according to the embodiment;

FIG. 5 is an external view illustrating an example of an image forming apparatus 4 according to the embodiment;

FIG. 6 is a diagram illustrating an example of the constitution of the image forming apparatus 4 according to the embodiment;

FIG. 7 is a diagram illustrating the operations of the management apparatus 1 according to the embodiment;

FIG. 8 is a diagram illustrating the operations of the portable terminal 2 according to the embodiment; and

FIG. 9 is a sequence diagram illustrating a method of printing user data of the portable terminal 2 in a case where the power of a power source 200 is turned off.

### DETAILED DESCRIPTION

In accordance with one embodiment, an image forming system comprises a portable terminal, a server and an image forming apparatus. The portable terminal includes a non-volatile memory and a control section. The non-volatile memory stores the personal authentication data for specifying a user. The control section sends the personal authentication data and user data to the server in a case where the remaining battery level value is less than a remaining level threshold value. The server includes a user data storage section. The user data storage section stores the personal authentication data and the user data sent from the portable terminal in an associated manner. The image forming apparatus includes a control section and a print section. The control section acquires the user data corresponding to the personal authentication data acquired from the non-volatile memory from the user data storage section. The print section prints the acquired user data.

The image forming system according to the embodiment is described below with reference to the accompanying drawings.

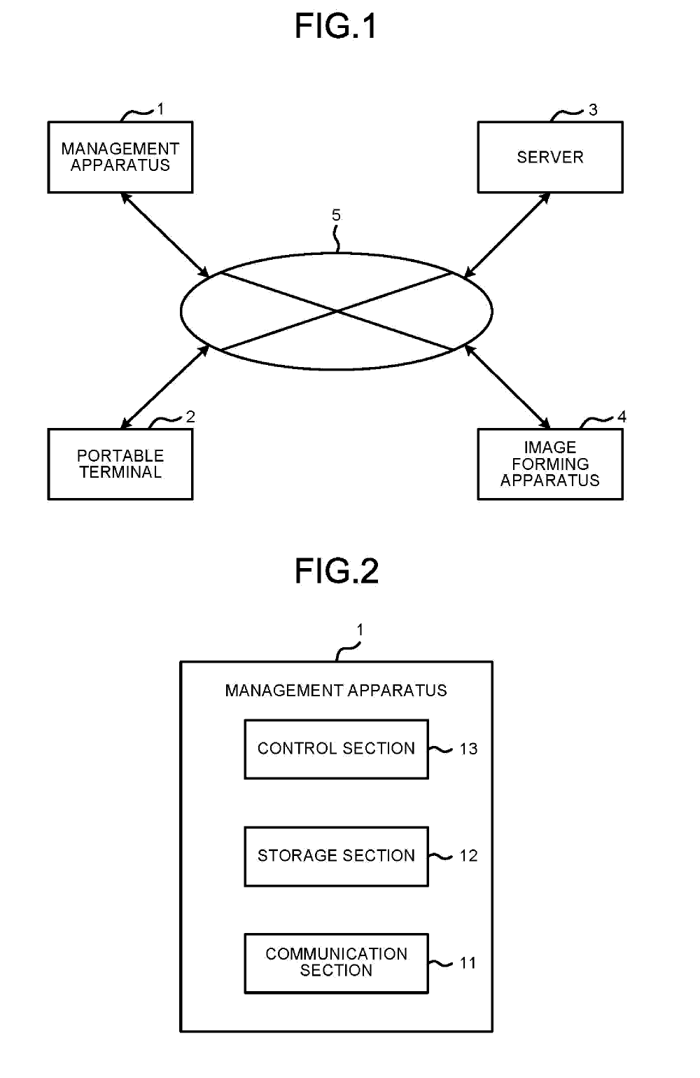

FIG. 1 is a diagram illustrating an example of the constitution of the image forming system according to the embodiment. The image forming system comprises a management apparatus 1, a portable terminal 2, a server 3 and an image forming apparatus 4.

The management apparatus 1 is an information processing apparatus which communicates with the portable terminal 2 through a network 5. The management apparatus 1 sends a request signal to the portable terminal 2. The request signal is a signal for requesting the portable terminal to reply a value (hereinafter referred to as “remaining battery level value”) indicating the remaining battery level of the portable terminal 2. For example, the remaining battery level value is represented with the power source voltage value of the portable terminal 2.

The portable terminal 2 communicates with the management apparatus 1 and the server 3 through the network 5. The portable terminal 2 is a portable terminal apparatus. For example, the portable terminal 2 is a mobile phone (including smart phone), a PDA (Personal Digital Assistant), a notebook PC, a tablet terminal, a portable music reproduction device or a portable video reproduction device. The portable terminal 2 sends a remaining battery level value to the management apparatus 1 if the request signal is received from the management apparatus 1. The portable terminal 2 uploads the data therein and the personal authentication data to the server 3 through the network 5. The personal authentication data is the information for authenticating the user of the portable terminal 2. For example, the personal authentication data is a user ID, a password and a phone number of the portable terminal 2.

The server 3 is an information processing apparatus which communicates with the portable terminal 2 and the image forming apparatus 4 through the network 5. The server 3 stores the data uploaded from the portable terminal 2 for each personal authentication data. The server 3 sends the print file based on the stored data to the image forming apparatus 4.

The image forming apparatus 4 communicates with the server 3 through the network 5. The image forming apparatus 4 is a multifunction printer (MFP). For example, the image forming apparatus 4 is a printer provided with a printing function, a scanning function, a copy function and a facsimile function.

FIG. 2 is a diagram illustrating an example of the constitution of the management apparatus 1 according to the embodiment. The management apparatus 1 is provided with a communication section 11, a storage section 12 and a control section 13.

The communication section 11 is a communication device having a wired communication function or a wireless communication function. The communication section 11 communicates with the portable terminal 2 through the network 5.

The storage section 12 is a storage device. For example, the storage section 12 is a ROM (Read Only Memory), a RAM (Random Access Memory), a flash memory or a hard disk device. The storage section 12 stores a threshold value (hereinafter referred to as “remaining level threshold value”) of the remaining battery level value. The remaining level threshold value is the voltage of a power source 200 of the portable terminal 2.

The control section 13 sends the request signal to the portable terminal 2 through the communication section 11 at given intervals. The control section 13 receives the remaining battery level value from the portable terminal 2 through the communication section 11. The control section 13 reads the remaining level threshold value from the storage section 12 if the remaining battery level value is received from the portable terminal 2. In a case where the remaining battery level value is less than the remaining level threshold value, the control section 13 sends a control signal to the portable terminal 2.

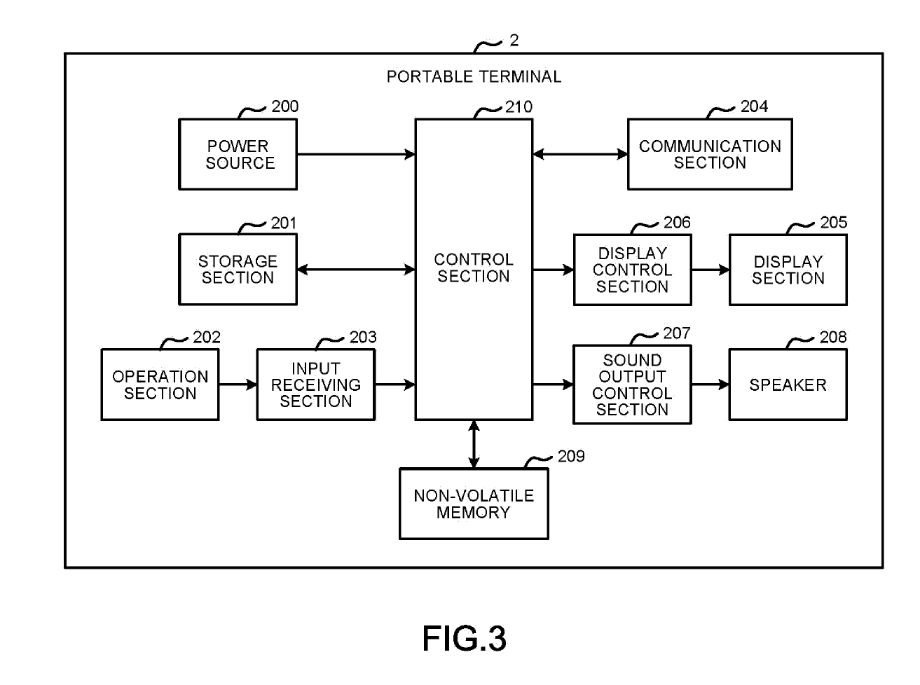

FIG. 3 is a diagram illustrating an example of the constitution of the portable terminal 2 according to the embodiment.

The portable terminal 2 comprises the power source 200, a storage section 201, an operation section 202, an input receiving section 203, a communication section 204, a display section 205, a display control section 206, a sound output control section 207, a speaker 208, a non-volatile memory 209 and a control section 210.

The power source 200 is a secondary battery called as battery. The power source 200 supplies power for each section of the portable terminal 2.

The storage section 201 is connected with the control section 210. The storage section 201 stores the user data. For example, the user data is phone book data, schedule management data, photograph data, video data, music file data, mail data, sound file data and document data. In addition, each user data is endowed with a unique data ID.

The operation section 202 includes operation keys, operation buttons, a switch, a jog dial and a touch pad. The input receiving section 203 receives an operation on the operation section 202 by the user and outputs a signal indicating the operation content to the control section 210.

The communication section 204 includes a communication control section and an antenna. The communication section 204 converts the signal for communication input from the control section 210 into a wireless signal and then sends the converted wireless signal to the management apparatus 1 and the server 3 through the antenna. The communication section 204 converts the wireless signal received through the antenna into a signal of a form which can be used by the control section 210. The communication section 204 outputs the converted signal to the control section 210.

The display section 205 is a display device. For example, the display section 205 is a LED (Light Emitting Diode) display, a liquid crystal display or an organic EL (Electro Luminescence) display.

The display control section 206 displays various screens on the display section 205 according to an instruction of the control section 210.

The sound output control section 207 outputs a sound from the speaker 208 according to an instruction of the control section 210.

The non-volatile memory 209 is a memory for storing personal authentication data. For example, the non-volatile memory 209 is a SIM (Subscriber Identity Module) card.

The control section 210 acquires the remaining battery level value of the power source 200 if the request signal is received from the management apparatus 1. For example, the control section 210 is provided with an I/O port which is connected with an output terminal of the power source 200. The control section 210 detects the voltage of the I/O port to acquire the output voltage value of the power source 200 as the remaining battery level value. The control section 210 sends the acquired remaining battery level value to the management apparatus 1 through the communication section 204. If the control signal is received, the control section 210 sends the personal authentication data and the user data to the server 3 through the communication section 204.

However, the control section 210 does not send the user data, which is sent to the server 3 once, to the server 3. For example, the control section 210 stores the data ID (hereinafter referred to as “sent data ID”) of the user data which has already been sent to the server 3 in a storage section (not shown). If the control signal is received from the management apparatus 1, the control section 210 compares the stored data ID with the sent data ID. The stored data ID is the data ID of all the user data stored in the storage section 201. The control section 210 sends the user data having a stored data ID different from the sent data ID to the server 3.

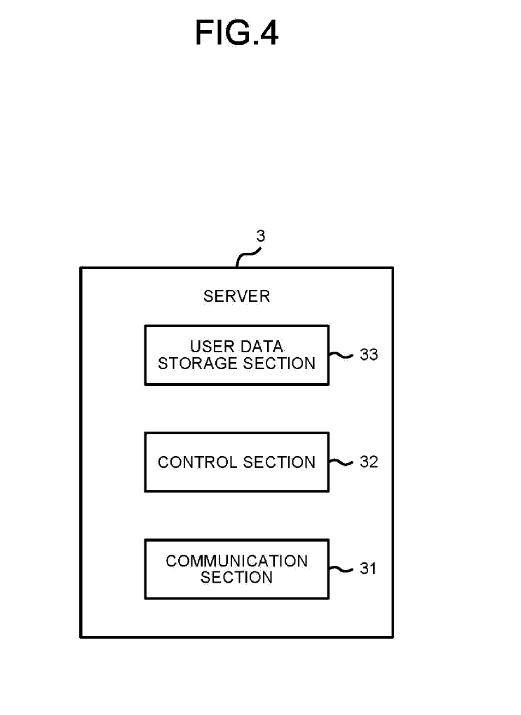

FIG. 4 is a diagram illustrating an example of the constitution of the server 3 according to the embodiment.

The server 3 comprises a communication section 31, a control section 32 and a user data storage section 33.

The communication section 31 is a communication device having a wired communication function or a wireless communication function. The communication section 31 communicates with the portable terminal 2 and the image forming apparatus 4 through the network 5.

The control section 32 receives the personal authentication data and the user data from the portable terminal 2. The control section 32 stores the user data received from the portable terminal 2 in the user data storage section 33 for each personal authentication data.

The control section 32 compares the personal authentication data acquired by the image forming apparatus 4 with the personal authentication data stored in the user data storage section 33. The control section 32 acquires a user data name of the user data corresponding to the consistent personal authentication data according to the comparison result. The control section 32 sends the acquired user data name to the image forming apparatus 4.

The control section 32 converts the user data into a print file if a request of print file is received from the image forming apparatus 4. The print file is a file with a print file form (extension prn) which can be used by the image forming apparatus 4 as the printing data. The control section 32 sends the converted print file to the image forming apparatus 4.

The user data storage section 33 is a storage device. For example, the user data storage section 33 is a ROM, a RAM, a flash memory or a hard disk device.

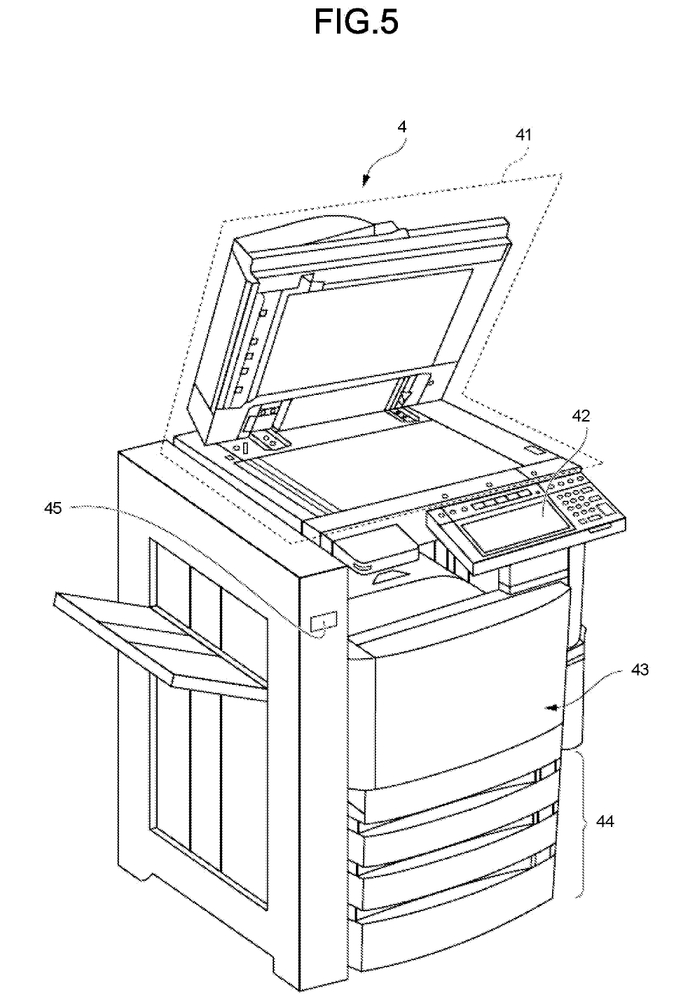

FIG. 5 is an external view illustrating an example of the image forming apparatus 4 according to the embodiment. The image forming apparatus 4 comprises a scanner section 41, a display section 42, a print section 43, a paper tray 44 and an insertion port 45.

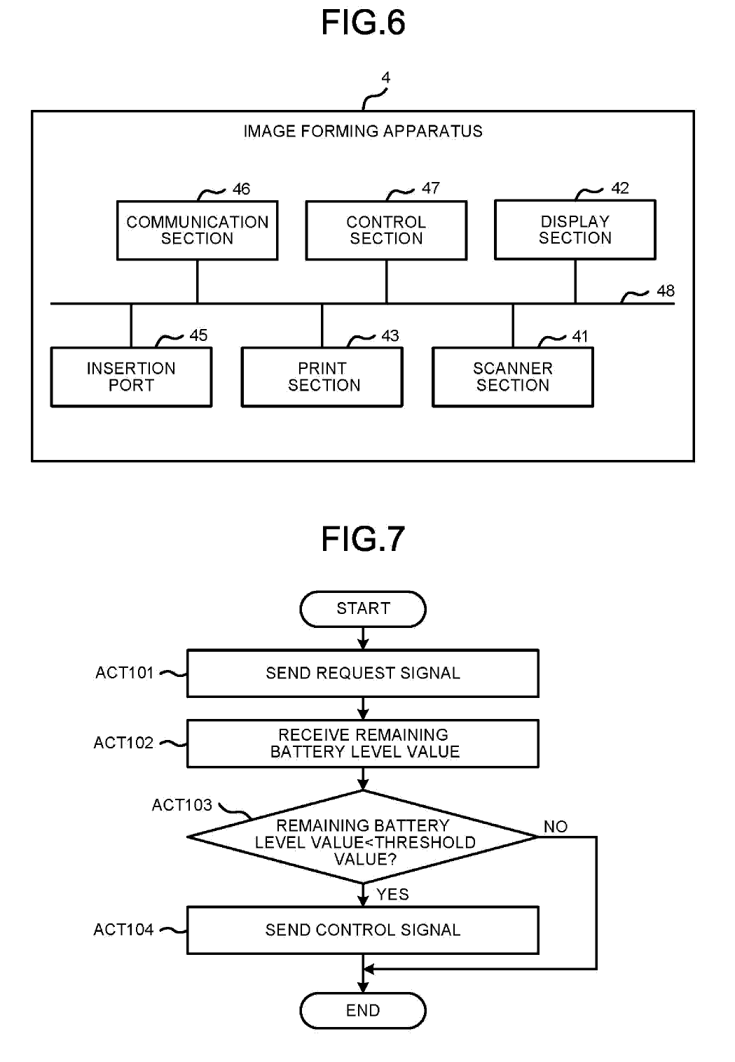

FIG. 6 is a block diagram illustrating an example of the constitution of the image forming apparatus 4 according to the embodiment. The image forming apparatus 4 comprises the scanner section 41, the display section 42, the print section 43, the insertion port 45, a communication section 46 and a control section 47. Further, the sections of the image forming apparatus 4 are connected with each other through an internal bus line 48. The sections of the image forming apparatus 4 input and output data to each other through the internal bus line 48.

The scanner section 41 is a color scanner. For example, the scanner section 41 comprises a CIS (Contact Image Sensor) or a CCD (Charge Coupled Devices). The scanner section 41 reads a sheet with a sensor to generate digital data.

The display section 42 is a liquid crystal display. For example, the display section 42 is provided with a touch panel. The display section 42 displays characters or images. Further, the display section 42 receives an instruction input from the user. If the print file sent from the server 3 is received from the control section 47, the print section 43 prints the image or the characters of the print file on a sheet.

The non-volatile memory 209 can be attached or detached from the insertion port 45.

The communication section 46 is a communication device having a wired communication function or a wireless communication function. The communication section 46 performs data transmission/reception with the server 3.

The control section 47 controls the operation of each section of the image forming apparatus 4. If the non-volatile memory 209 is inserted, the control section 47 acquires the personal authentication data from the non-volatile memory 209.

Next, the operations of the management apparatus 1 are described with reference to the accompanying drawings. FIG. 7 is a diagram illustrating the operations of the management apparatus 1 according to the embodiment. The control section 13 sends the request signal to the portable terminal 2 through the communication section 11 at given intervals (ACT 101). The control section 13 receives the remaining battery level value from the portable terminal 2 every time it sends the request signal to the portable terminal 2 (ACT 102).

Next, the control section 13 reads the remaining level threshold value from the storage section 12. The control section 13 determines whether or not the remaining battery level value is less than the remaining level threshold value (ACT 103). If the remaining battery level value is less than the remaining level threshold value (YES in ACT 103), the control section 13 sends the control signal to the portable terminal 2 (ACT 104). On the other hand, if the remaining battery level value is greater than the remaining level threshold value (NO in ACT 103), the control section 13 does not send the control signal to the portable terminal 2.

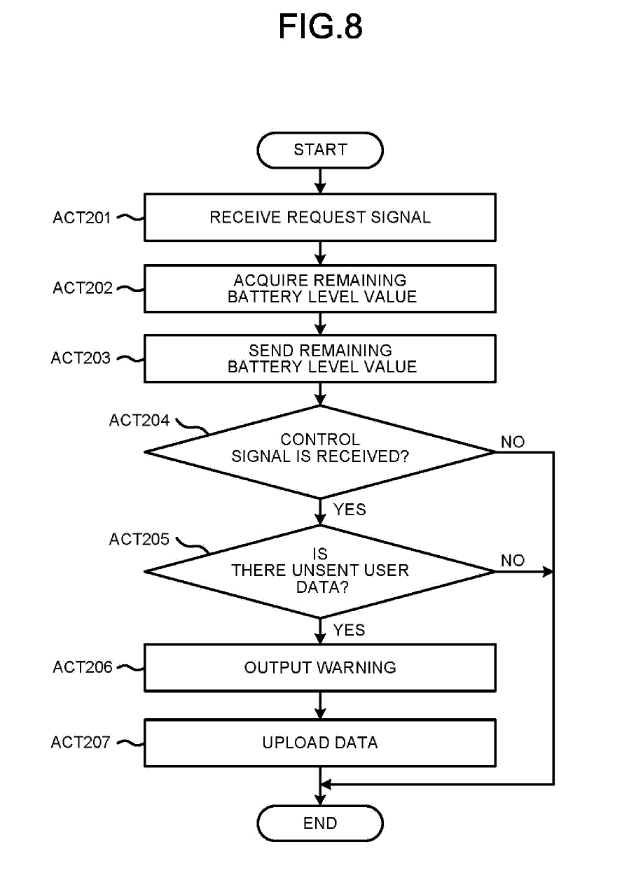

Next, the operations of the portable terminal 2 are described with reference to the accompanying drawings. FIG. 8 is a diagram illustrating the operations of the portable terminal 2 according to the embodiment. The control section 210 receives the request signal from the management apparatus 1 (ACT 201). The control section 210 acquires the remaining battery level value of the power source 200 if the request signal is received from the management apparatus 1 (ACT 202). The control section 210 sends the acquired remaining battery level value to the management apparatus 1 (ACT 203).

The control section 210 determines whether or not the control signal is received from the management apparatus 1 (ACT 204). If the control signal is not received from the management apparatus 1 (NO in ACT 204), the control section 210 does not send the user data. If the control signal is received from the management apparatus 1 (YES in ACT 204), the control section 210 determines whether or not there is unsent user data (ACT 205). The unsent user data is the user data which has never been sent to the server 3.

In a case where the stored data ID is consistent with the sent data ID, the control section 210 determines that there is no unsent user data. On the other hand, in a case where the stored data ID is not consistent with the sent data ID, the control section 210 determines that there is unsent user data.

If the control section 210 determines that there is no unsent user data (NO in ACT 205), the user data is not sent to the server 3. On the other hand, if the control section 210 determines that there is unsent user data (YES in ACT 205), a warning is given to the user (ACT 206).

The control section 210 warns the user by displaying a pop-up message and outputting a sound. The control section 210 gives a command to display the pop-up message on the display control section 206. The display control section 206 displays the pop-up message indicating to send the unsent user data to the server 3 on the display section 205. Further, the control section 210 gives a command to the sound output control section 207 to output a warning sound. The sound output control section 207 outputs a warning sound, which indicates to send the unsent user data to the server 3, from the speaker 208.

The control section 210 sends the personal authentication data and the unsent user data to the server 3 (ACT 207). The control section 210 stores the data ID of the sent user data in a storage section (not shown).

Next, a method of printing the user data of the portable terminal 2 in a case where the power of the power source 200 is turned off is described.

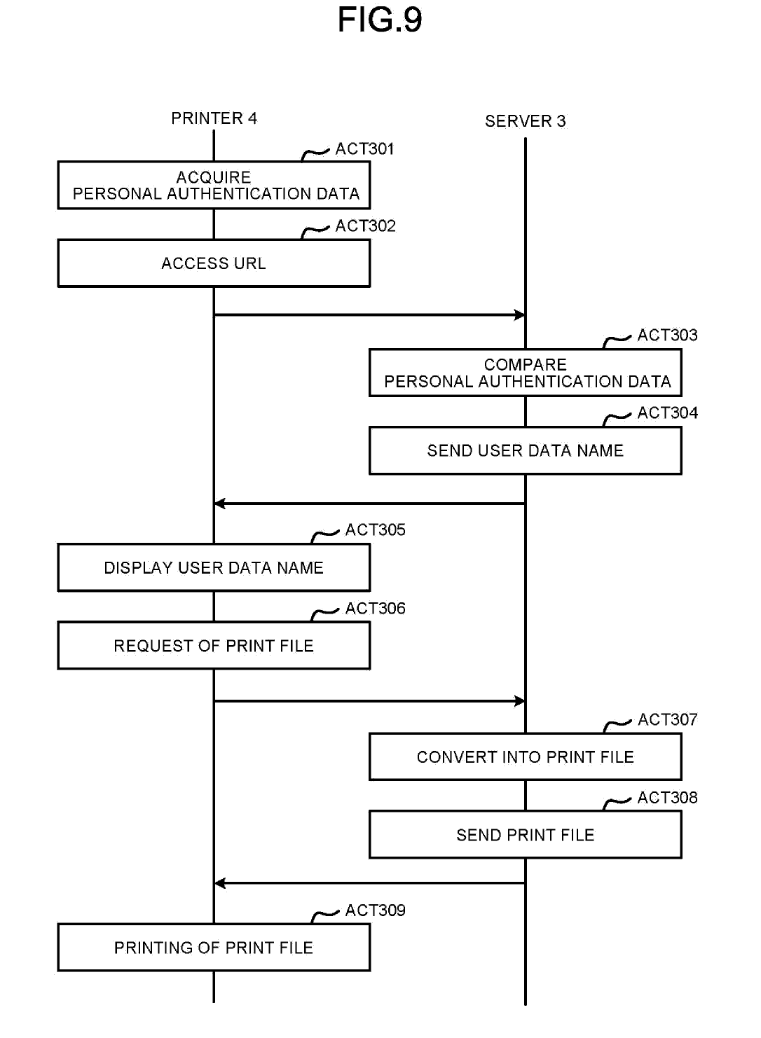

FIG. 9 is a sequence diagram illustrating the method of printing the user data of the portable terminal 2 in a case where the power of the power source 200 is turned off.

The user takes out the non-volatile memory 209 from the portable terminal 2 the power of which is turned off and then inserts the non-volatile memory 209 taken out from the portable terminal 2 into the insertion port 45 of the image forming apparatus 4. The control section 47 acquires the personal authentication data from the inserted non-volatile memory 209 (ACT 301). The control section 47 accesses the URL (Uniform Resource Locator) of the server 3 (ACT 302). The control section 47 inputs the acquired personal authentication data to the server 3. The control section 32 compares the acquired personal authentication data with the personal authentication data stored in the user data storage section 33 (ACT 303).

The control section 32 acquires the user data name corresponding to the consistent personal authentication data according to the comparison result. The control section 32 sends the acquired user data name to the communication section 46 through the communication section 31 (ACT 304).

The control section 47 displays the acquired user data name on the display section 42 arranged in the image forming apparatus 4 (ACT 305). The user selects the user data name of the user data desired to print from the user data names displayed on the display section 42 through the touch panel and the like of the display section 42. The control section 47 requests the server 3 to acquire the print file of the user data selected by the user (ACT 306).

The control section 32 converts the user data selected by the user into the print file (ACT 307). The control section 32 sends the converted print file to the communication section 46 (ACT 308). The control section 47 acquires the converted print file from the communication section 46 and sends the file to the print section 43.

If the print file sent from the control section 47 is received, the print section 43 prints the print file (ACT 309).

In accordance with at least one embodiment described above, the portable terminal 2 sends the user data to the server 3 before the power thereof is turned off. Then, after the power of the portable terminal 2 is turned off, the image forming apparatus 4 acquires user data using the personal authentication data in the non-volatile memory 209. In this way, even if the power of the portable terminal 2 is turned off, the user data in the portable terminal 2 can be printed.

In the embodiment described above, the image forming apparatus 4 may be an image forming apparatus which fixes a toner image or an inkjet-type image forming apparatus.

In the embodiment described above, the portable terminal 2 may or may not include the function of the management apparatus 1.

In the embodiment described above, it is exemplified that the image forming apparatus 4 acquires the personal authentication data from the non-volatile memory 209; however, the present invention is not limited to this. For example, the user manually inputs the personal authentication data using the operation section such as a keyboard and the like, thereby, the image forming apparatus 4 acquires the personal authentication data.

Further, in the embodiment described above, it is exemplified that the portable terminal 2 determines the unsent user data using the data ID; however, the present invention is not limited to this. For example, the portable terminal 2 stores the history (hereinafter referred to as “transmission history”) of the transmission of the user data to the server 3 for each user data. Then the portable terminal 2 retrieves the user data without any transmission history, thereby determining the unsent user data.

In the embodiment described above, the remaining battery level value voltage value is described as the output voltage value of the power source 200; however, the present invention is not limited to this. For example, the remaining battery level value voltage value may be a percentage value. The percentage value indicates the percentage of the battery voltage remaining level against the capacity of the power source 200.

Further, in the embodiment described above, it is exemplified that the user data is converted into the print file by the server 3; however, the present invention is not limited to this. For example, the user data may be converted into the print file by the image forming apparatus 4.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. An image forming system, comprising:
a portable terminal including a non-volatile memory which stores personal authentication data for specifying a user, and a first control section which sends the personal authentication data and the user data in a case where remaining battery level value of the portable terminal is less than a remaining level threshold value;
a server including a user data storage section for storing the personal authentication data and the user data in association with each other, the personal authentication data and the user data having been sent from the portable terminal in the case where the remaining battery level value of the portable terminal is less than the remaining level threshold value; and
an image forming apparatus including a second control section which acquires, from the user data storage section, the user data associated with the personal authentication data acquired from the non-volatile memory, and a print section which prints the acquired user data.

2. The image forming system according to claim 1, wherein
the control section of the portable terminal outputs at least one of a preset warning sound and message in a case of sending the user data to the server.

3. The image forming system according to claim 1, wherein
the control section of the portable terminal determines whether or not the user data has already been sent to the server, and
the control section of the portable terminal sends the personal authentication data and the user data, which is not sent yet, to the server.

4. The image forming system according to claim 1, wherein
the control section of the portable terminal stores a data ID or transmission history of the sent user data in a storage section in a case of sending the user data to the server.

5. The image forming system according to claim 1, wherein
the non-volatile memory is a SIM card.

6. The image forming system according to claim 1, wherein
the control section of the image forming apparatus acquires the personal authentication data through the insertion of the non-volatile memory into the insertion port of the image forming apparatus.

7. The image forming system according to claim 1, wherein
a user manually inputs the personal authentication data through a display section arranged in the image forming apparatus, thereby, the control section of the image forming apparatus acquires the personal authentication data.

8. The image forming system according to claim 1, further comprising:
a management apparatus configured to request the portable terminal to reply the remaining battery level value at given intervals.

9. The image forming system according to claim 1, wherein
the remaining battery level value is the power source voltage value of the portable terminal.

10. An image forming method, comprising:
sending, from a portable terminal, personal authentication data and user data stored in a non-volatile memory in a case where a remaining battery level value is less than a remaining level threshold value;
storing, in a user data storage section, the personal authentication data and the user data in association with each other, the personal authentication data and the user data having been sent from the portable terminal in the case where the remaining battery level value of the portable terminal is less than the remaining level threshold value;
acquiring, from the user data storage section, the user data associated with the personal authentication data acquired from the non-volatile memory; and
printing the acquired user data.
